(19) United States
(12) Patent Application Publication
(10) Pub. No.: US 2011/0122051 A1
(43) Pub. Date: May 26, 2011

(54) HEAD-MOUNTED DISPLAY

(75) Inventor: Seon-Myeong Choi, Gyeongsangbuk-do (KR)

(73) Assignee: Postech Academy Industry Foundation

(21) Appl. No.: 13/055,012

(22) PCT Filed: Aug. 10, 2008
(86) PCT No.: PCT/KR2009/004436

§ 371 Date: Jan. 20, 2011

(30) Foreign Application Priority Data
Aug. 13, 2008 (KR) 1020080079212

(51) Int. Cl. G09G 5/00

(52) U.S. Cl. 345/8

(57) ABSTRACT

A head-mounted display is provided which includes a spectacled body, a display unit, and an image transmitting unit. The spectacled body faces a user's eyeball. The display unit is disposed inside the spectacled body so as to project an image to the eyeball. The image transmitting unit is disposed inside the spectacled body with a predetermined distance from the display unit and has a fine hole formed therein so as to guide the image to the eyeball through the fine hole. Since no lens is used, the weight of the head-mounted display can be reduced. Since a crystalline lens's relaxation and shrinkage has not influence on forming an image on the retina, no additional device corresponding to a user's sight is required, thereby simplifying the structure.

### TECHNICAL FIELD

The present invention relates to a display, and more particularly, to a head-mounted display allowing a user to clearly watch an image displayed on a display such as an LCD disposed close to the user's eyes.

### BACKGROUND ART

With the development of display apparatuses, imaging apparatuses have decreased in size and weight. Such imaging apparatuses are called head-mounted displays. In general, the head-mounted displays were developed as a kind of visual display mounted on a user's head for use in a virtual reality (VR) system or the like and have been used in more and more fields. The head-mounted display is an apparatus allowing a user to watch an image displayed by a display device such as an LCD or a CRT using a precise optical mechanism. The head-mounted display should have convenience in wearing and carrying. Therefore, it is preferable that the head-mounted display more decreases in size and weight.

In such as a head-mounted display, since a screen is located very close to the user's eyes, the focal length should be very short. In addition, very precise optical elements are required to prevent the eyes from feeling fatigued. Some products currently coming to the market have a structure for magnifying an image from a display device with high resolution and small size using a magnifying mechanism such as a lens and thus allowing the eyes to easily recognize the image.

However, such a structure tends to enhance the weight of the head-mounted display due to the lens. In addition, since an additional device depending on a user's sight, that is, a lens position adjusting device depending on the sight or the user's spectacle, is required, the weight of the product may increase or inconvenience may be caused.

Therefore, there is a need for a head-mounted display allowing a user to clearly watch an image without any additional device such as a lens.

### DISCLOSURE OF INVENTION

### Technical Problem

The invention provides a head-mounted display allowing a user to clearly watch an image displayed on a display by disposing a device intercepting an image between the display and the user's eyes and transmitting only a beam in a specific direction out of beams of the image generated from the display.

### Solution to Problem

According to an aspect of the invention, there is provided a head-mounted display including a spectacled body, a display unit, and an image transmitting unit. The spectacled body faces a user's eyeball. The display unit is disposed inside the spectacled body so as to project an image to the eyeball. The image transmitting unit is disposed inside the spectacled body with a predetermined distance from the display unit and has a fine hole formed therein so as to guide the image to the eyeball through the fine hole.

### Advantageous Effects of Invention

In the head-mounted display according to the aspect of the invention, since no lens is used, the weight of the head-mounted display can be reduced. In addition, since a crystalline lens's relaxation and shrinkage has not influence on forming an image on the retina, no additional device corresponding to a user's sight is required, thereby simplifying the structure.

### BRIEF DESCRIPTION OF DRAWINGS

FIG. 1 is a diagram illustrating an example of a head-mounted display.

FIG. 2 is a side view illustrating an image displaying method in the head-mounted display.

FIG. 3 is a diagram illustrating another example of the head-mounted display.

FIG. 4 is a diagram illustrating another example of the head-mounted display.

FIG. 5 is a diagram illustrating another example of the head-mounted display.

FIG. 6 is a diagram illustrating another example of the head-mounted display.

FIG. 7 is a diagram illustrating another example of the head-mounted display.

### MODE FOR THE INVENTION

Hereinafter, the invention will be described in detail.

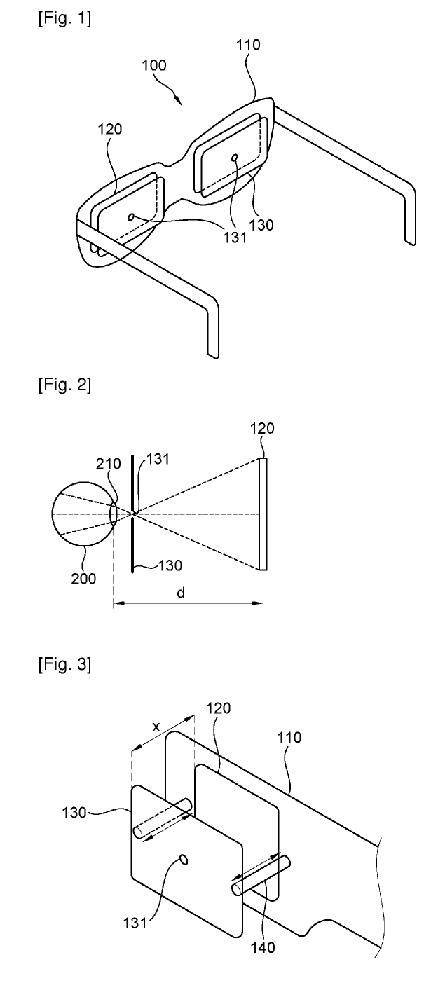

FIG. 1 is a diagram illustrating a head-mounted display.

Referring to FIG. 1, a head-mounted display 100 includes a spectacled body 110, a display unit 120, and an image transmitting unit 130.

The spectacled body 110 corresponds to a body of the head-mounted display disposed in the front of a user's eyeball. The shape of the spectacled body 110 is not particularly limited. Any shape may be employed as long as it can be disposed and fixed in the front of the eyeball when it is worn.

The display unit 120 is disposed inside the spectacled body 110 and serves to project an image to the user's eyeball. The display unit 120 may be disposed for each of the left eyeball and the right eyeball or may be disposed for both of the left eyeball and the right eyeball. The display unit 120 may include any image display displaying an image, such as an LCD (Liquid Crystal Display), a PDP (Plasma Display Panel), a CRT (Cathode Ray Tube), and an OLED (Organic Light Emitting Diodes).

The image transmitting unit 130 has a fine hole 131 formed therein so as to transmit the image from the display unit 120 and is disposed inside the spectacled body 110 and between the eyeball and the display unit 120. The image transmitting unit 130 transmits the image via the fine hole 131 to guide the image to the eyeball and the portion of the image transmitting unit 130 other than the fine hole 131 intercepts the transmission of the image. In the drawing, a single fine hole 131 is formed at the center of the image transmitting unit 130, but the number of fine holes 131 may be two or more or the fine hole may be formed at a position other than the center.

The diameter of the fine hole 131 can be determined depending on the screen size of the display unit 120, the distance between the image transmitting unit 130 and the display unit 120, or the distance between the display unit 120 and the eyeball. The material of the image transmitting unit 130 is not particularly limited as long as it has the fine hole 131 formed therein. That is, when the image transmitting unit 130 is formed of a light material, it is possible to accomplish the decrease in weight and size of the head-mounted display.

FIG. 2 is a side view illustrating an image displaying method in the head-mounted display.

Referring to FIG. 2, the broken lines indicate paths of beams passing through the fine hole 131 out of beams emitted from the upper end, the lower end, and the center of the display unit 120. Only the beams having specific paths out of the image beams emitted from all positions of the display unit 120 pass through a crystalline lens 210 of the eyeball 200 via the fine hole 131 formed in the image transmitting unit 130. Since the beams having the paths passing through the fine hole 131 pass through only specific parts of the crystalline lens 210, not the entire parts thereof, the shrinkage and relaxation of the crystalline lens 210 for focusing the beams do not have an influence on forming an image on the retina. When the intensity of the beams having the paths passing through the fine hole 131 is enough for the retina to perceive, the eye can perceive the image from the display unit 120. In this way, by using the image transmitting unit 130 according to the invention, the relaxation and shrinkage of the crystalline lens 210 have no influence on forming an image on the retina and thus an additional device depending on the user's sight is not required. Since the distance d between the display unit 120 and the eyeball 200 can be reduced, it is possible to reduce the volume of the head-mounted display.

FIG. 3 is a diagram illustrating another example of the head-mounted display.

Referring to FIG. 3, the head-mounted display 100 further includes a distance adjusting unit 140 adjusting the distance x between the display unit 120 and the image transmitting unit 130.

The distance adjusting unit 140 is connected to the spectacled body 110 and the image transmitting unit 130. The distance adjusting unit 140 serves to move the image transmitting unit 130 by allowing the image transmitting unit 130 to get close to the display unit 120 or to get apart from the display unit 120 while keeping parallel to the display unit 120 depending on the user's will. By adjusting the distance between the display unit 120 and the image transmitting unit 130 to transmit the image according to the size of the user's crystalline lens, it is possible to easily adjust the visual angle.

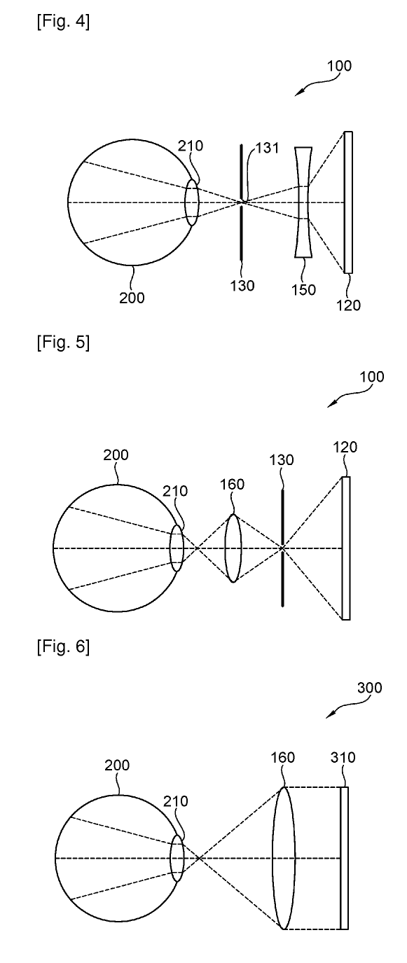

FIG. 4 is a diagram illustrating another example of the head-mounted display.

Referring to FIG. 4, the head-mounted display 100 includes a display unit 120, an image transmitting unit 130, and a concave lens 150. The concave lens 150 is disposed between the display unit 120 and the image transmitting unit 130 and the optical path shown in FIG. 4 can be formed by the concave lens 150. Accordingly, since the display unit 120 can be located closer to the image transmitting unit 130, it is possible to further reduce the size of the head-mounted display.

FIG. 5 is a diagram illustrating another example of the head-mounted display.

Referring to FIG. 5, the head-mounted display 100 includes a display unit 120, an image transmitting unit 130, and a convex lens 160. The convex lens 160 is disposed between the eyeball 200 and the image transmitting unit 130 and serves to invert upside, downside, left and right of the original image so as not to show the inverse image and to guide the inverted image to the crystalline lens 210. The convex lens 160 can formed the optical path shown in FIG. 5 and thus can allow a user to recognize the enlarged image. Since the distance between the head-mounted display 100 and the eyeball 200 can be made to further increase, it is possible to prevent an eye from being hurt.

FIG. 6 is a diagram illustrating another example of the head-mounted display.

Referring to FIG. 6, the head-mounted display 300 includes a convex lens 160 and a display unit 310. The display unit 310 emits light beams, which are generated from dots of an image, in only the direction perpendicular to the front surface thereof by means of two sheets of comb-shaped films with a thickness overlapping perpendicularly to each other or a porous film with a thickness. The convex lens 160 is disposed between the display unit 310 and the eyeball 200 and can allow the user to clearly watch the image from the display unit 310 close thereto by concentrating the optical paths on the crystalline lens 210.

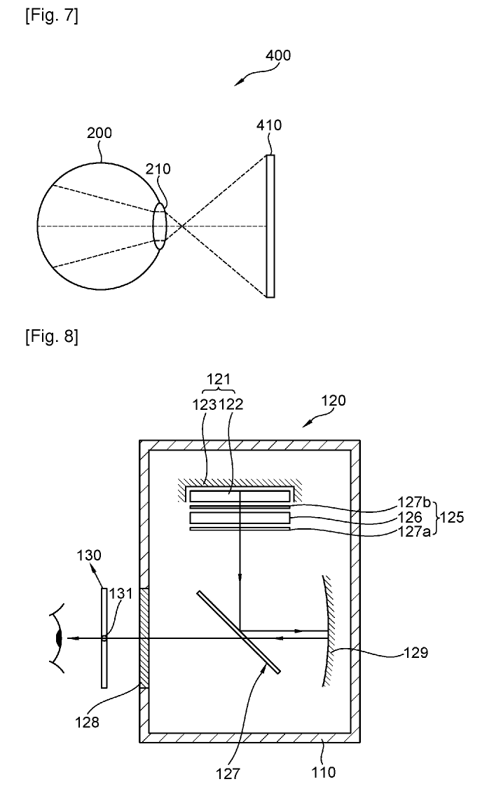

FIG. 7 is a diagram illustrating another example of the head-mounted display.

Referring to FIG. 7, the head-mounted display 400 includes a display unit 410. The display unit 410 concentrates beams emitted from dots of an output image on a position between the eyeball 200 and the display unit 410.

FIG. 8 is a block diagram illustrating an optical configuration of the display unit.

Referring to FIG. 8, the display unit 120 includes a backlight source 121, image generating means 125 selectively transmitting beams emitted from the backlight source 121 to form an image, a spherical mirror 129, and a half mirror 127 reflecting the beam transmitted by the image generating means 125 toward the spherical mirror 129 and transmitting the beam reflected by the spherical mirror 129 toward the user's eye. The display unit 120 is disposed inside the spectacled body 110 with a structure mounted on a human head and the beam reflected by the spherical mirror 129 and transmitted by the half mirror 127 travels to the user's eye via a window 128.

The backlight source 121 includes a lamp 122 as a light emitting member such as a fluorescent lamp and a mirror 123 disposed on one surface of the lamp 122 so as to allow the beam emitted from the lamp 122 in one direction. The image generating means 125 includes a transmissive liquid crystal display device 126, which includes two-dimensionally arranged pixels and which is independently driven in the unit of pixels, and a pair of polarizers 127a and 127b disposed in the back and front of the liquid crystal display device 126.

1. A head-mounted display comprising:
a spectacled body facing a user's eyeball;
a display unit disposed inside the spectacled body and projecting an image to the eyeball; and
an image transmitting unit disposed inside the spectacled body with a predetermined distance from the display unit, wherein the image transmitting unit has a fine hole formed therein so as to guide the image to the eyeball through the fine hole

2. The head-mounted display according to claim 1, wherein the fine hole is formed at the center of the image transmitting unit.

3. The head-mounted display according to claim 1, wherein the number of fine holes is one or more.

4. The head-mounted display according to claim 1, further comprising a distance adjusting unit smoothly moving the image transmitting unit by allowing the image transmitting unit to get close to the display unit or to get apart from the display unit while the image transmitting unit is kept parallel to the display unit.

5. The head-mounted display according to claim 1, further comprising a concave lens disposed inside the spectacled body and between the image transmitting unit and the display unit.

6. The head-mounted display according to claim 1, further comprising a convex lens disposed inside the spectacled body and between the image transmitting unit and the user's eyeball.

7. The head-mounted display according to claim 6, further comprising a concave lens disposed inside the spectacled body and between the image transmitting unit and the display unit.

8. A head-mounted display comprising:
a spectacled body facing a user's eyeball;
a display unit disposed inside the spectacled body so as to project an image beam to the eyeball only in a direction perpendicular to the front surface thereof; and
a convex lens disposed inside the spectacled body and between the user's eyeball and the display unit,
wherein the convex lens concentrates the image beam to the crystalline lens of the eyeball.

9. A head-mounted display comprising:
a spectacled body facing a user's eyeball; and
a display unit disposed inside the spectacled body so as to project an image to the eyeball;
wherein the display unit concentrically projects a beam of the image to a point between the eyeball and the display unit.

10. The head-mounted display according to claim 9, wherein the display unit includes image generating means for generating an image by selectively transmitting a beam emitted from a backlight source and the image generating means is a transmissive liquid crystal display device which includes two-dimensionally arranged pixels and which is independently driven in the unit of pixels.
